(19) United States
(12) Patent Application Publication
(10) Pub. No.: US 2012/0324691 A1
(43) Pub. Date: Dec. 27, 2012

(54) Counter Sprocket Installation And Removal Tool

(76) Inventor: Kenneth Martin Strub, Escondido, CA (US)

(21) Appl. No.: 13/168,846

(22) Filed: Jun. 24, 2011

(51) Int. Cl. B25B 27/14

(52) U.S. Cl. 29/283

(57) ABSTRACT

A counter sprocket rotational movement limiting device for installing and removing the fasteners of counter sprockets on motorcycles, comprising of a profile which will engage the teeth of the sprocket and a protruding arm or set of arms configured to come to rest on the top and or bottom of the swingarm, limiting the rotational movement of the counter sprocket.

### FIELD OF THE INVENTION

The invention relates to a mechanical device capable of holding a counter sprocket from rotating during installation and removal of the fastening device typically a bolt or nut, while not creating an undue side load on the output shaft or transferring an unnecessary impact to the drive train.

### BACKGROUND OF THE INVENTION

A counter sprocket is secured to a splined output shaft on the motor of chain drive motorcycles. The counter sprocket is typically secured with a bolt or nut, to the output shaft. This bolt or nut has specific torque specifications to achieve maximum effectiveness. The output shaft is designed to be as close as possible to the pivot point of the swingarm to minimize the distance change of the sprockets during articulation of the swingarm. Over time there may be corrosion or other factors, which may require much more torque to remove the nut or bolt from the output shaft. Past procedures include putting the transmission in gear to create a resistance on the output shaft and use an impact gun to remove the fastener. This method can damage the transmission gears. An alternative method has been to use a wedge between the sprocket and the swingarm, this can cause excessive side load on the motor housing and output shaft, another opportunity for damage. During installation of the fastener, a specific torque setting is required. To achieve the specific torque the output shaft must be held rotationally solid for an accurate setting. By holding the sprocket from rotational movement the interaction of the splined shaft and the spline teeth in the sprocket the shaft is thus prevented from moving.

### SUMMARY OF THE INVENTION

The present invention is targeted at simplifying the operation of installation and removal of the counter sprocket fastener on a motorcycle. It specifically is a device to prevent rotation of the counter sprocket thereby preventing rotation of the output shaft to facilitate removal of the bolt or nut securing the counter sprocket to the output shaft. The device is intended to hold the counter sprocket from rotation during installation of the securing fastener to achieve a specific torque value. Once in place the device will hold itself in position so the mechanic can focus on the tool being used for installation or removal of the fastener. The drive system can be either electric, internal combustion, or other technologies available. The invention is an improvement in that it eliminates potential damage during the operation and also simplifies the operation from past art.

### BRIEF DESCRIPTION OF THE DRAWING

FIG. 1 is a front view of the preferred embodiment positioned on the counter-sprocket.

### DETAILED DESCRIPTION OF THE INVENTION

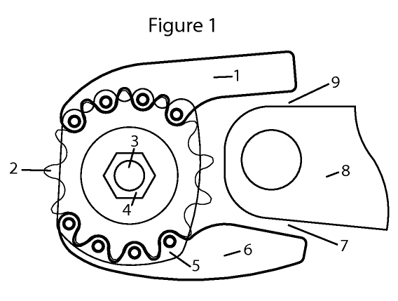

Referring to FIG. 1, a motorcycle has an output shaft 3 from the motor. A counter sprocket 2 is mounted to the output shaft 3 with a fastener 4. The fastener 4 is typically a threaded nut or bolt. The counter sprocket removal tool, consisting of three parts in this embodiment, the faceplate 5 connected to the 2 engagement arms 1 and 6. Depending on installation or removal, the force is either clockwise or counter-clockwise. During installation, the fastener 4 would need to be rotated clockwise about the output shaft 3. The engagement arms 1,6 are meshed with the teeth of the sprocket 2. When the output shaft 3 tries to rotate, the counter sprocket 2 which has a mating spline pattern, must rotate with the output shaft 3. The counter sprocket tool as depicted in FIG. 1 shows the engagement arms 1,6 interlocked in the counter sprocket 2. This engagement would require the counter sprocket tool to rotate with the counter sprocket 2. The upper engagement arm 1 will come to a stop point 9 on the upper surface of swingarm 8 preventing clockwise rotation. Similarly during removal when the fastener needs to be removed, turning counterclockwise the lower engagement arm 6 will come to a stop at point 7 under the swingarm 8. The engagement arms 1,6 can also be configured to engage a rigid portion of the frame. This could also create a scenario where only one engagement arm is required.

What is claimed is:

1: a device to engage the counter sprocket of a motorcycle with 1 arm protruding which will limit rotation of the counter sprocket by engaging the upper or lower surface of the swingarm depending on installation or removal of the fastener. The protrusion will be configured to transfer the force to the upper or lower surface of the swing arm as not to create a wedge effect side load to the output shaft. When the protrusion engages the upper or lower surface of the swingarm the rotational movement will be prevented allowing the installation or removal of the counter sprocket fastener.

2: A device to engage the counter sprocket of a motorcycle with 2 arms protruding which go above and below the swingarm, the engagement arms configured to contact independently the upper and lower surface of the swingarm to limit rotational movement of the counter sprocket during installation and or removal of the fastener which secures the counter sprocket to the output shaft of the drive system.

3: an adjustable device which can adapt to different size sprockets and will engage the sprocket teeth which can be made with one or two engagement arms, the engagement arms configured to contact the upper and/or lower surface of the swing arm to limit rotational movement of the counter sprocket during installation and or removal of the fastener which secures the counter sprocket to the output shaft of the drive system.

4: a device which can have interchangeable components to adapt to different size sprockets, which can have one or two engagement arms, the engagement arms configured to contact the upper and/or lower surface of the swing arm to limit rotational movement of the counter sprocket during installation and or removal of the fastener which secures the counter sprocket to the output shaft of the drive system.

5: a device configured to interlock to the teeth of the counter sprocket and has at least one engagement arm protrusion configured to contact a rigid portion of the motorcycle such as the foot peg or frame in such a way to limit rotational movement of the counter sprocket during installation or removal of the fastener.
